(19) United States
(12) Patent Application Publication
(10) Pub. No.: US 2022/0402678 A1
(43) Pub. Date: Dec. 22, 2022

(54) VACUUM-PUMPING BOTTLE STOPPER

(71) Applicant: DANPING LIU, Shenzhen City, Guangdong Province (CN)

(72) Inventor: DANPING LIU, Shenzhen City, Guangdong Province (CN)

(21) Appl. No.: 17/778,826

(22) PCT Filed: Feb. 18, 2020
(86) PCT No.: PCT/CN2020/075777

§ 371 Date: May 20, 2022

(51) Int. Cl. B65D 81/20; B65D 39/00; G01K 1/02; G01K 1/14

(52) U.S. Cl. CPC B65D 81/2038; B65D 39/0052; G01K 1/028; G01K 1/14

(57) ABSTRACT

Provided is a vacuum-pumping bottle stopper, comprising a base, a shell which can enclose a cavity with the base, a vacuum-pumping device arranged in the cavity and used for pumping out air in a bottle to form a vacuum, a temperature measurement unit, and a temperature display unit, wherein the temperature measurement unit is used for measuring the temperature in the bottle; and the temperature display unit is electrically connected to the temperature measurement unit and is used for displaying the temperature measured by the temperature measurement unit. The temperature measurement unit and the temperature display unit are integrated on the vacuum-pumping bottle stopper, such that the temperature of the liquid in the bottle can be conveniently measured, thereby improving the use satisfaction for a user.

### FIELD OF THE INVENTION

The present application relates to a technical field of food preservation, in particular to a vacuum-pumping bottle stopper.

### BACKGROUND OF THE INVENTION

Wine stoppers are mostly wooden corks. When people drink wine, they often can't finish a whole bottle. Once wine is exposed to air, it will be oxidized, which affects the taste of next drink. Therefore, there is a problem of preservation of the remaining red wine. The existing vacuum-pumping bottle stopper applied to the bottle opening, can extract the air in the wine bottle and prevent the outside air from entering the bottle, so as to realize preservation of the remaining wine in the bottle and ensure the taste of the wine of next drink. However, the function of the existing vacuum-pumping bottle stopper is relatively simple, and when the user wants to know the temperature of the wine in the bottle, it is necessary to use a special temperature measuring instrument to measure, which is relatively inconvenient.

### SUMMARY OF THE INVENTION

### Technical Problem

An object of this application is aim to provide a vacuum-pumping bottle stopper that can detect and display a temperature of wine in the bottle.

### Technical Solutions

In order to obtain the object, the present application provides the following technical solutions:

A vacuum-pumping bottle stopper comprises a base, a casing that encloses a chamber together with the base, a vacuum device arranged in the chamber and used to extract the air in the bottle to form a vacuum, a temperature detection unit and a temperature display unit. The temperature detection unit is used to detect a temperature in the bottle, and the temperature display unit is electrically connected to the temperature detection unit and used to display the temperature detected by the temperature detection unit.

Preferably, the casing comprises a light-transmitting top cover; the temperature display unit comprises a PCB, a display module, a touch sensor switch and a button battery; the touch sensor switch and the button battery are respectively arranged on opposite sides of the PCB and are electrically connected to the PCB; one end of the touch sensor switch is abutted against the light-transmitting top cover, whereby the display module can be triggered to display the temperature when the light-transmitting top cover is pressed.

Preferably, the temperature detection unit comprises an infrared transducer arranged on the PCB.

Preferably, the light-transmitting top cover is a translucent cover, an inner side of which is coated with a conductive medium; the touch-sensing switch is a sensor spring, has one end abutted against the inner side of the light-transmitting top cover, and the other end is connected to the PCB.

Preferably, the base is provided with a boss that can be inserted in the bottle opening; the vacuum-pumping device comprises a vacuum pump, a battery assembly for supplying power to the vacuum pump and an identification component for detecting the vacuum degree in the bottle, the boss defines an air guide hole for connecting the vacuum pump and the bottle, the identification component is electrically connected with the vacuum pump to automatically control on-off of a control circuit of the vacuum pump.

Preferably, the identification component comprises a silicone disc and a tactile switch; the base forms a detection cavity corresponding to the tactile switch, the detection cavity is communicated with the air guide hole; the silicone disc seals an opening of the detection cavity towards the chamber, and forms a weak part at the opening; the tactile switch is electrically connected with the vacuum pump and pressed against the silicone disc on the weak part.

Preferably, the weak part has a tapered surface that can be arched in a direction from the detection cavity towards the chamber, and the tapered surface can be recessed in reverse under an outer air pressure when the bottle is in a vacuum state.

Preferably, an opposite side of the base away from the boss is provided with a sealing cavity communicating with the air guide hole, a positioning protrusion is formed in the sealing cavity, the sealing cavity is also provided with a sealing plug; the sealing plug defines a positioning hole at center therethrough; the positioning hole can communicate with the air guide hole and the vacuum pump, and can be engaged with the positioning protrusion and tightly fit with the positioning protrusion when the bottle is evacuated; the positioning hole is arranged in a tapered manner in a direction from the base toward the casing.

Further, the vacuum-pumping bottle stopper comprises an anti-tilt switch electrically connected with the vacuuming device, the anti-tilt switch is used to detect an inclination of a bottle body and stop the vacuuming device from working when the inclination reaches a preset angle.

### Advantages

Compared with prior art, the present application has the following advantages:

the vacuum-pumping bottle stopper of the present application is provided with a vacuum device, so that the air in the bottle can be drawn out, and the bottle is kept in a vacuum state to ensure the quality of the liquid in the bottle; in addition, the bottle stopper has a temperature detection and display units which can measure and display the temperature in the bottle, and does not need to use a special temperature measuring device to measure the temperature, which is convenient to use, and can improve user satisfaction.

In the vacuum-pumping bottle stopper of the present application, a weak part with a tapered surface is provided on the silicone disc, and the weak part can be arched in a direction from the base towards t the casing, and can be recessed in reverse in a direction from the casing to the base during vacuum. The movable contact of the tactile switch is pressed against the weak part. The movable contact of the tactile switch is disconnected from the static contact during vacuum, so that the vacuum pump stops pumping; and the vacuum degree in the bottle can be automatically detected and a working state of the vacuum pump is automatically controlled. It is beneficial to improve the detection accuracy by setting the weak part with a tapered surface.

In the vacuum-pumping bottle stopper of the present application, the sealing plug defines a conical positioning hole; the positioning hole in the sealing plug can be communicated with the air guide hole and the vacuum pump; and the positioning hole in the sealing plug can be tightly engaged with the positioning protrusion formed on the base during vacuum so as to seal the bottle at a vacuum; further, due to a pressure of other parts above the sealing plug, the sealing plug has a certain deformation, which improves the sealing effect to the bottle.

Additional aspects and advantages of the present application will be partly illustrated in the following description, which will become apparent from the following description, or be learned by practice of the present application.

### BRIEF DESCRIPTION OF THE DRAWINGS

The above-mentioned and/or additional aspects and advantages of the present application will become apparent and readily understood from the following description of embodiments in conjunction with the accompanying drawings, wherein:

FIG. 1 is the exploded view of a vacuum-pumping bottle stopper in accordance with an embodiment of the present application;

FIG. 2 is a perspective view of a base in accordance with an embodiment of the present application;

FIG. 3 is another perspective view of the base of FIG. 2;

FIG. 4 is a perspective view of a temperature detection and display units in accordance with an embodiment of the present application;

FIG. 5 is a perspective view of a disk made of silicone in accordance with an embodiment of the present application;

FIG. 6 is a perspective view of a sealing plug in accordance with an embodiment of the present application; and

FIG. 7 is another perspective view of the sealing plug of FIG. 6.

### DETAILED DESCRIPTION OF THE INVENTION

Embodiments of the present application are described in detail below, examples of which are illustrated in the accompanying drawings, wherein the same or similar reference numerals refer to the same or similar elements or elements having the same or similar functions. The embodiments described below with reference to the accompanying drawings are exemplary and are only used to explain the present application, but not to be construed as a limitation on the present application.

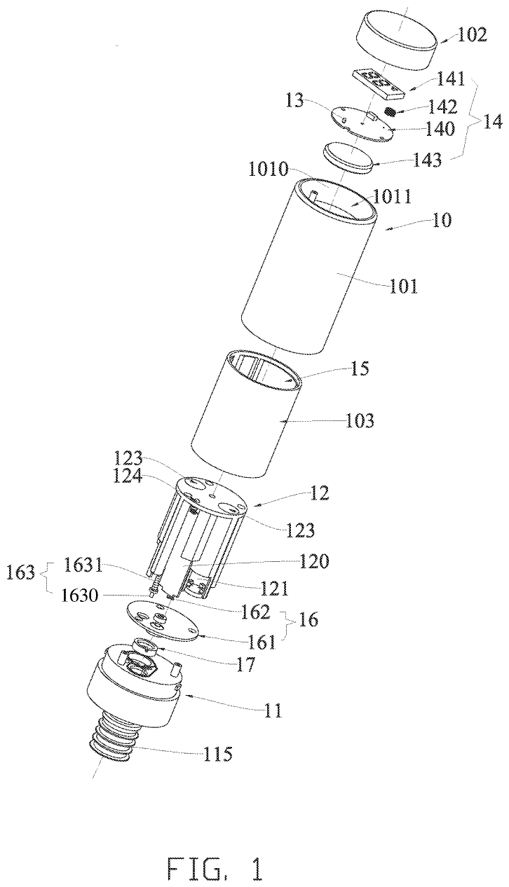

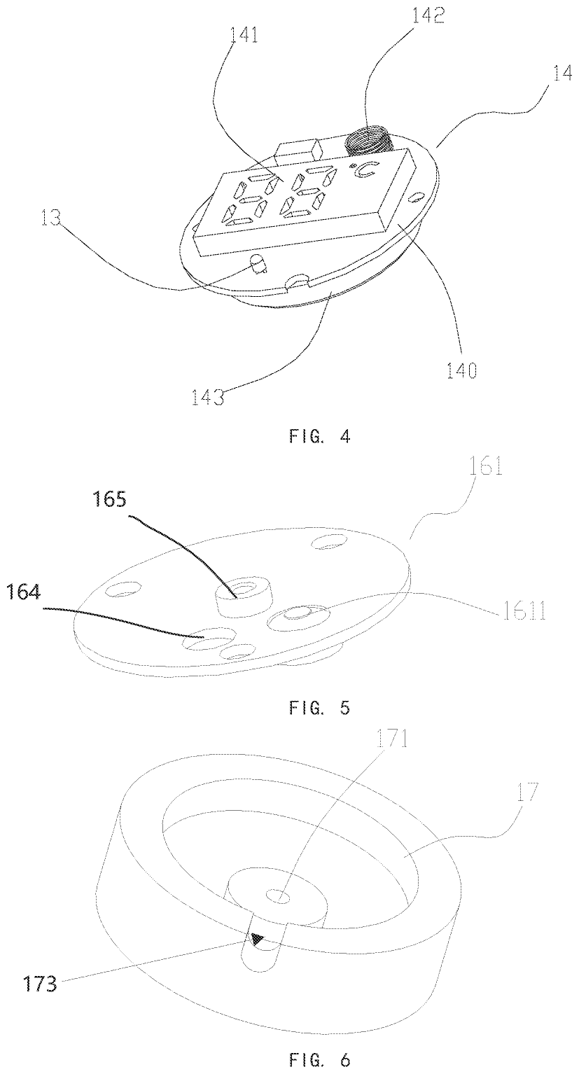

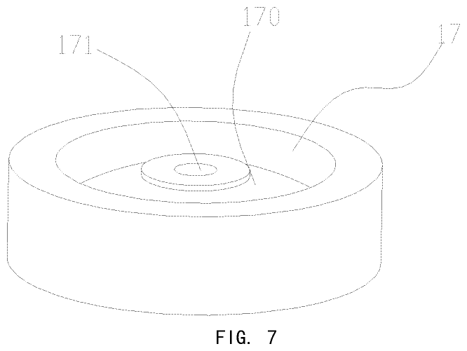

Referring to FIGS. 1 to 7, the present application relates to a vacuum-pumping bottle stopper 1, which can be capped at an opening of a bottle (such as a wine bottle), used to pump out air in the bottle to form a vacuum, so as to ensure the quality of the liquid in the bottle (such as the taste of wine). Further, the bottle stopper comprises a temperature detection unit and a temperature display unit 14, which can measure and display the real-time temperature in the bottle, it is more convenient to use and additional separate special temperature measuring device is not necessary.

The vacuum-pumping bottle stopper 1 includes a base 11, a casing 10, a vacuuming device, a temperature detection unit and a temperature display unit 14.

The base 11 can be sleeved on a bottle opening, and is provided with a boss 111 that can be plugged into the bottle opening. The boss 111 defines an air guide hole 110 that can communicate with an inside of the bottle. A silicone ring 115 is sleeved on the boss 111 and can extend into the bottle opening. The surface of the silicone 115 is provided with threads therearound. When the boss 111 is plugged into the bottle opening, the silicone ring 115 can be squeezed and deformed so as to seal the bottle opening.

The casing 10 includes an outer casing 101, an inner casing 103 and a light-transmitting top cover 102. The inner casing 103 is arranged in the outer casing 101 and is connected to the base 11 (e.g., snap-connection) and jointly encloses a chamber 15; a receiving groove 1010 is formed in a top of the outer casing 101. The light-transmitting top cover 102 covers the open top of the receiving groove 1010 and defines the closed space together with the outer casing 101 for receiving the temperature detection unit and the temperature display unit.

The vacuuming device 12 is arranged in the chamber 15 and below the receiving groove 1010, and includes a vacuum pump (not shown, the same below), a battery assembly (not shown, the same below) for powering the vacuum pump and an identification component 16 for detecting the vacuum level in the bottle. The vacuum pump communicates with the air guide hole 110 to draw out air within the bottle through the air guide hole 110. The identification component is electrically connected with the vacuum pump to automatically control the on-off of a control circuit of the vacuum pump.

Referring to FIG. 3, the temperature detection module 14 and a temperature display module are placed in the receiving groove 1010. The temperature display module 14 is electrically connected to the temperature detection module, and is used for displaying the temperature in the bottle detected by the temperature detection unit. The temperature display unit 14 includes a PCB (printed circuit board) 140, a display module 141 constructed by digital tubes, a spring sensor 142 and a button battery 143. The digital tubes and the spring sensor are all arranged on a front side of the PCB and are electrically connected to the PCB. The button battery is arranged on the back side of the PCB and is used to supply power to the temperature display unit 14. Where one end of the spring sensor is abutted against an inner side of the light-transmitting top cover 102 and the other end is connected to the PCB.

When the light-transmitting top cover 102 is touched, the spring sensor receives a touch signal and transmits it to the PCB, so that the PCB controls the display module to display the temperature. In other embodiments, the spring sensor may be replaced with other types of touch sensitive switches.

Preferably, the light-transmitting top cover 102 may be a translucent cover, the inner side of which is coated with a conductive medium. The temperature detection unit includes an infrared transducer 13, which is set on the PCB.

Therefore, via the temperature detection unit and the temperature display unit 14 of the bottle stopper, the temperature in the bottle, such as the temperature of wine, can be easily detected, which is convenient for users and improves user satisfaction.

Please refer to FIG. 1 and FIG. 5, in one embodiment, the identification component includes a silicone disc 161 and a tactile switch 162. The base 11 forms a detection cavity 113 at a position corresponding to the tactile switch, and communicating with an air guide hole 110. The silicone disc seals the detection cavity 113, and has a weak part 1611 with a tapered surface formed corresponding to the opening of the detection cavity 113. The weak part 1611 can be arched in a direction from the base 11 towards the casing 10, and reversely, can be recessed in a direction from the casing 10 to the base 11 during vacuum. The tactile switch is electrically connected with the vacuum pump, a movable contact of the tactile switch can press against the silicone disc, and which is set in such manner that: when there is air in the bottle, the weak part 1611 of the silicone disc 161 is arched, so that the movable contact is connected to a static contact of the tactile switch to turn on the control circuit of the vacuum pump to draw air in the bottle; when the bottle is vacuumed, the weak part is compressed under an outside air and recessed into the detection cavity 113, so that the movement contact of the tactile switch is separated from the static contact, the control circuit of the vacuum pump is disconnected, and the pumping is stopped.

The bottle stopper 1 of the present application detects the vacuum degree in the bottle by means of the identification component, which can automatically control the start and stop of the vacuum pump, with a high degree of automation, the detection can be completed by the silicone disc and the tactile switch, and the cost is low. In addition, the part in contact with the contact of the tactile switch is set as a tapered surface, and a deformation distance is 3 to 4 times greater than that of the non-tapered surface, which greatly improves the detection sensitivity and accuracy.

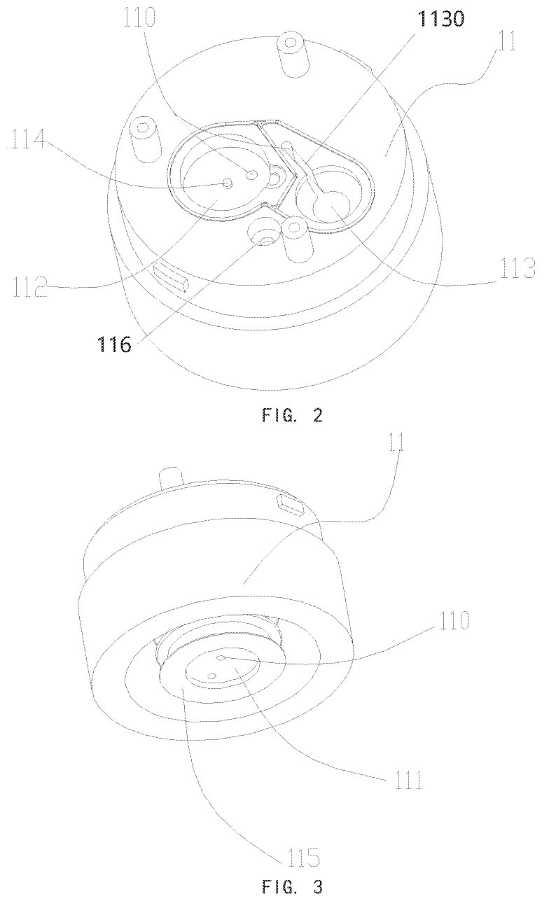

Please refer to FIGS. 2, 6 and 7, preferably, one side of the base 11 away from the boss 111 is forms a sealing cavity 112 communicating with one air guide hole 110. A positioning protrusion 114 and a sealing plug 17 are arranged in the sealing cavity 112. The sealing plug 17 is preferably made of silicone material, and forms a tapered surface 170 in center thereof. The tapered surface defines a positioning hole 171 therethrough that can communicate with the air guide hole 110 and the vacuum pump, and can sleeve the positioning protrusion 114 and tightly fit with the positioning protrusion 114 when the bottle is evacuated. Wherein, the positioning hole is formed in a tapered manner in a direction from the base 11 to the casing 10, that is, the positioning hole is a tapered hole. The parts of the bottle stopper 1 above the sealing plug can apply a downward pressure on the sealing plug, the tapered surface has a deformation, so that a better sealing effect to the bottle is obtained under such a downward pressure which is always maintained. Even if a pressure difference between the internal and outer of cavity 112 is small, the deformation of the tapered surface of the sealing plug can obtain a good sealing effect.

Further, the vacuum-pumping bottle stopper 1 of the present application also includes an anti-tilt switch electrically connected with the vacuuming device 12, and the anti-tilt switch is used to detect an inclination of the bottle body and stop the vacuuming device from working when the inclination is at a preset angle, so as to prevent the vacuum pump from continuing to work when the bottle is inclined to pump the liquid into the chamber 15 and damage the electrical components of the vacuum-pumping bottle stopper, so as to ensure the normal use of the vacuum-pumping bottle stopper.

The above are only some embodiments of the present application. It should be pointed out that for those skilled in the art, without departing from the principles of the present application, several improvements and modifications can be made. It should be regarded as the protection scope of this application.

1: A vacuum-pumping bottle stopper, comprising: a base, a casing that encloses a chamber together with the base, and a vacuuming device which is set in the chamber and is used to draw out air in the bottle to form a vacuum; wherein the vacuum-pumping bottle stopper further comprises a temperature detection unit and a temperature display unit, the temperature detection unit is used for detecting a temperature in the bottle, the temperature display unit is electrically connected with the temperature detection unit and is used for displaying the temperature detected by the temperature detection unit.

2: The vacuum-pumping bottle stopper of claim 1, wherein the casing comprises a light-transmitting top cover for observing the temperature display unit; the temperature display unit comprises a PCB (printed circuit board), a display module, and a touch sensor switch; the touch sensor switch and the display module are electrically connected to the PCB; one end of the touch sensor switch is abutted against the light-transmitting top cover, whereby the display module can be triggered to display the temperature when the light-transmitting top cover is pressed.

3: The vacuum-pumping bottle stopper of claim 2, wherein the temperature detection unit comprises a temperature transducer which is electrically connected with the PCB.

4: The vacuum-pumping bottle stopper of claim 2, wherein the light-transmitting top cover is a translucent cover, an inner side of which is coated with a conductive medium for being electrically connected to one end of the touch sensor switch; the touch-sensing switch is a sensor spring, has one end abutted against the inner side of the light-transmitting top cover, and the other end is connected to the PCB.

5: The vacuum-pumping bottle stopper of claim 1, wherein the base is provided with a boss that can be inserted in the bottle opening; the vacuum-pumping device comprises a vacuum pump, a battery assembly for supplying power to the vacuum pump, a main control board and an identification component for detecting the vacuum degree in the bottle, the boss defines an air guide hole for connecting the and the bottle, the identification component is electrically connected with the main control board to automatically control on-off of the vacuum pump.

6: The vacuum-pumping bottle stopper of claim 5, wherein the identification component comprises a silicone disc and a tactile switch; the base forms a detection cavity corresponding to the tactile switch, the detection cavity is communicate with the air guide hole; the silicone disc seals an opening of the detection cavity towards the chamber, and forms a weak part at the opening; the tactile switch is electrically connected with the main control board and pressed against the silicone disc on the weak part.

7: The vacuum-pumping bottle stopper of claim 6, wherein the weak part has a tapered surface that can be arched in a direction from the detection cavity towards the chamber, and the tapered surface can be recessed in reverse under an outer air pressure when the bottle is in a vacuum state.

8: The vacuum-pumping bottle stopper of claim 6, wherein an opposite side of the base away from the boss is provided with a sealing cavity communicating with the air guide hole, a positioning protrusion is formed in the sealing cavity, the sealing cavity is also provided with a sealing plug; the sealing plug defines a positioning hole at center therethrough; the positioning hole can communicate with the air guide hole and the vacuum pump, and can be engaged with the positioning protrusion and tightly fit with the positioning protrusion when the bottle is evacuated; the positioning hole is arranged in a tapered manner in a direction from the base toward the casing.

9: The vacuum-pumping bottle stopper of claim 1, further comprising an anti-tilt switch electrically connected with the main control board, wherein the anti-tilt switch is used to detect an inclination of a bottle body and stop the vacuuming device from working when the inclination reaches a preset angle.

10: The vacuum-pumping bottle stopper of claim 5, wherein the PCB of the temperature display unit is electrically connected with the main control board.

11: The vacuum-pumping bottle stopper of claim 8, wherein there are two air guide holes defined through a height of the boss, a first air guide hole is used to connect the vacuum pump with an inside of the bottle to evacuate, and a second air guide hole is used to connect the detection cavity with an inside of the bottle so as to detect a vacuum degree in the bottle using the identification component; a top end of the first air guide hole is located in the detection cavity; the detection cavity is communicated with the second air guide hole through a guide groove so that a vacuum degree or air pressure in the detection cavity consistent with that in the bottle.

12: The vacuum-pumping bottle stopper of claim 6, wherein there is another tactile switch used to automatically trigger the vacuum pump once the bottle stopper is plugged into the bottle opening.

13: The vacuum-pumping bottle stopper of claim 12, wherein another tactile switch electrically connected with the main control board, a movable contact of which comprises a guiding post with a spring thereon; the guiding post extends through the silicone disc and the case via with a bottom end thereof extending beside the boss; a static contact of the tactile switch is set on the main control board.

14: The vacuum-pumping bottle stopper of claim 13, wherein an indicator light is electrically connected to the main control board, is used to represent a working state of the vacuum pump, and can be observed from the light-transmitting top cover.
